(19) United States
(12) Patent Application Publication
(10) Pub. No.: US 2017/0243295 A1
(43) Pub. Date: Aug. 24, 2017

(54) GRAPHICAL USER INTERFACE FOR DISPLAYING DYNAMIC STRATEGIES

(71) Applicant: AlphaVee Solutions Ltd., Binyamina (IL)

(72) Inventors: Moshe KOVARSKY, Nes Ziona (IL); Shlomo ALMOG, Rehovot (IL)

(21) Appl. No.: 15/436,811

(22) Filed: Feb. 19, 2017

Related U.S. Application Data
(60) Provisional application No. 62/298,032, filed on Feb. 22, 2016.

(51) Int. Cl. G06Q 40/06; G06F 3/0482

(52) U.S. Cl. CPC G06Q 40/06; G06F 3/0482

(57) ABSTRACT

There is provided a method of displaying results of a financial data analysis on a graphical user interface (GUI), comprising: receiving, using the GUI, a definition of a growth grade, a definition of a value grade, and a definition of a requirement of the growth grade and the value grade, computing the growth grade and the value grade for each of the plurality of stocks according to the performance data, selecting a subset of the stocks according to the requirement, computing an aggregated growth grade and an aggregated value grade for the subset of stocks, and presenting, within the GUI, a matrix of investment strategies, where each cell of the matrix stores an investment strategy according to a row and column of ranges of growth grades and value grade, wherein the cell of the matrix corresponding to the aggregated growth grade and the aggregated value grade is visually demarcated.

### RELATED APPLICATION

This application claims the benefit of priority under 35 USC §119(e) of U.S. Provisional Patent Application No. 62/298,032 filed on Feb. 22, 2016, the contents of which are incorporated herein by reference in their entirety.

### FIELD AND BACKGROUND OF THE INVENTION

The present invention, in some embodiments thereof, relates to a graphical user interface (GUI) and, more particularly, but not exclusively, to methods and systems of displaying financial data analysis using a GUI.

Financial assets managers struggle daily to define the right blend of asset allocation which will yield the optimal results in the current market condition. The decision how to allocate the type of assets is no less important than the selection of the underlying instruments in each asset class, be it stocks, bonds, shorted stocks or any other instrument.

During the last few years, various methods and systems have been developed to predict market behavior based on technical indicators, e.g., market price fluctuation. Such methods which are based on techniques such as moving averages and relative strength may provide partial benefits but are still lacking accuracy.

### SUMMARY OF THE INVENTION

According to a first aspect, a computerized method of displaying results of a financial data analysis on a graphical user interface (GUI), comprises: accessing a dataset storing performance data of a plurality of stocks traded on at least one stock market, receiving, using the GUI, a definition of a growth grade, a definition of a value grade, and a definition of a requirement of the growth grade and the value grade, computing the growth grade and the value grade for each of the plurality of stocks according to the performance data, selecting a subset of the stocks according to the requirement of the computed growth grade and value grade computed for each stock of the plurality of stocks, computing an aggregated growth grade and an aggregated value grade for the subset of stocks according to the computed growth grade and value grade computed for each stock of the subset of stocks, and presenting, within the GUI, a matrix of investment strategies, where each cell of the matrix stores an investment strategy according to a row and column of ranges of growth grades and value grade, wherein the cell of the matrix corresponding to the aggregated growth grade and the aggregated value grade is marked with a visual marker.

According to a second aspect, a system for displaying results of a financial data analysis on a graphical user interface (GUI), comprises: a non-transitory memory having stored thereon a code for execution by at least one hardware processor of a computing device, the code comprising: code for accessing a dataset storing performance data of a plurality of stocks traded on at least one stock market, code for receiving, using the GUI, a definition of a growth grade, a definition of a value grade, and a definition of a requirement of the growth grade and the value grade, code for computing the growth grade and the value grade for each of the plurality of stocks according to the performance data, code for selecting a subset of the stocks according to the requirement of the computed growth grade and value grade computed for each stock of the plurality of stocks, code for computing an aggregated growth grade and an aggregated value grade for the subset of stocks according to the computed growth grade and value grade computed for each stock of the subset of stocks, code for presenting, within the GUI, a matrix of investment strategies, where each cell of the matrix stores an investment strategy according to a row and column of ranges of growth grades and value grade, wherein the cell of the matrix corresponding to the aggregated growth grade and the aggregated value grade is marked with a visual marker.

According to a third aspect, a computer program product for displaying results of a financial data analysis on a graphical user interface (GUI), comprises: a non-transitory memory having stored thereon a code for execution by at least one hardware processor of a computing device, the code comprising: instructions for accessing a dataset storing performance data of a plurality of stocks traded on at least one stock market, instructions for receiving, using the GUI, a definition of a growth grade, a definition of a value grade, and a definition of a requirement of the growth grade and the value grade, instructions for computing the growth grade and the value grade for each of the plurality of stocks according to the performance data, instructions for selecting a subset of the stocks according to the requirement of the computed growth grade and value grade computed for each stock of the plurality of stocks, instructions for computing an aggregated growth grade and an aggregated value grade for the subset of stocks according to the computed growth grade and value grade computed for each stock of the subset of stocks, instructions for presenting, within the GUI, a matrix of investment strategies, where each cell of the matrix stores an investment strategy according to a row and column of ranges of growth grades and value grade, wherein the cell of the matrix corresponding to the aggregated growth grade and the aggregated value grade is marked with a visual marker.

The systems and/or methods (e.g., code instructions stored in a data storage device executed by one or more processors) described herein do not simply display information using a GUI. The systems and/or methods described herein are based on a specific, structured GUI paired with a prescribed functionality directly related to the GUI's structure that is addressed to and resolves a specifically identified problem.

The systems and/or methods (e.g., code instructions stored in a data storage device executed by one or more processors) described herein provide a technical solution to the problem of rapidly analyzing a large volume of performance data of companies traded on stock exchanges, to determine an overall investment strategy, for example, for a portfolio of a client, and/or for a managed mutual fund. Determination of the overall investment strategy is repeatedly performed, for example, daily or weekly, for example, to account for rapidly changing market and/or economic conditions. Daily adjustments of the overall investment strategy are labor intensive, for example, due to the need to re-evaluate performance of stocks. The GUI described herein provides a mechanism for adapting one or more parameters of the computation of the investment strategy, and rapidly updating the GUI to present the updated investment strategy according to the adapted parameter(s). The investment strategy selection presented by the GUI may be easily executed on a frequency basis (e.g., hourly, daily, weekly), and may optionally be automatically and dynamically updated according to updated data.

In a first possible implementation of the system according to the first aspect or the method according to the second aspect or the computer program product according to the third aspect, the aggregated growth and value grades are computed based on the average growth and value grades of the subset of the plurality of stocks and changes in the averages.

In a second possible implementation of the system according to the first implementation, the system, the method, and the computer program product further comprise code and/or instructions for performing a back testing simulation of performance of the subset of stocks, comparing the results of the stimulation to a known benchmark, and presenting within the GUI the comparison results.

In a third possible implementation form of the system according to the first aspect as such, or the method according to the second aspect as such, or the computer program product according to the third aspect as such, or according to any of the preceding forms of the first or second or third aspects, the plurality of stocks consist of a stock sector selected using the GUI.

In a fourth possible implementation form of the system according to the first aspect as such, or the method according to the second aspect as such, or the computer program product according to the third aspect as such, or according to any of the preceding forms of the first or second or third aspects, the growth grade is used to define the rows of the matrix and the value grade is used to define the column of the matrix.

In a fifth possible implementation form according to the fourth possible implementation, an aggregated sector growth grade computed for stocks of the stock sector is used to modify the sector weight as compared to the sector weight in a known benchmark

In a sixth possible implementation form according to the fifth possible implementation, the investment strategies of cells of the matrix are dynamically updated according to the modified sector weight in comparison to the known benchmark, and dynamically presenting the updated investment strategies using the GUI.

In a seventh possible implementation form of the system according to the first aspect as such, or the method according to the second aspect as such, or the computer program product according to the third aspect as such, or according to any of the preceding forms of the first or second or third aspects, the system or method or computer program product further comprise code or instructions for dynamically receiving using the GUI, an adjustment to at least one of: the definition of the growth grade, the definition of the value grade, and the definition the requirement, and dynamically updating the visually marked cell in the matrix of investment strategies according to a re-computation using the dynamic adjustment.

In an eighth possible implementation form of the system according to the first aspect as such, or the method according to the second aspect as such, or the computer program product according to the third aspect as such, or according to any of the preceding forms of the first or second or third aspects, the system or method or computer program product further comprise code or instructions for dynamically receiving an update of the performance data of at least one of the plurality of stocks, and dynamically updating the visually marked cell in the matrix of investment strategies according to a re-computation using the updated performance data.

In a ninth possible implementation form of the system according to the first aspect as such, or the method according to the second aspect as such, or the computer program product according to the third aspect as such, or according to any of the preceding forms of the first or second or third aspects, the system or method or computer program product further comprise code or instructions for dynamically receiving, using the GUI, a past date, and dynamically updating the visually marked cell in the matrix of investment strategies according to a re-computation using the performance data of the past date.

In a tenth possible implementation form of the system according to the first aspect as such, or the method according to the second aspect as such, or the computer program product according to the third aspect as such, or according to any of the preceding forms of the first or second or third aspects, the system or method or computer program product further comprise code or instructions for dynamically receiving, using the GUI, a selection of one of the cells of the matrix, and presenting using the GUI, assets and weights associated with the investment strategy of the selected cell.

In an eleventh possible implementation form of the system according to the first aspect as such, or the method according to the second aspect as such, or the computer program product according to the third aspect as such, or according to any of the preceding forms of the first or second or third aspects, the system or method or computer program product further comprise code or instructions for filtering the stocks according to a set-of-rules defined by a user using the GUI, including one or more of: size, domicile, exchange, and sector.

In a twelfth possible implementation form of the system according to the first aspect as such, or the method according to the second aspect as such, or the computer program product according to the third aspect as such, or according to any of the preceding forms of the first or second or third aspects, the system or method or computer program product further comprise code or instructions for computing changes of the aggregated growth rate over a time interval entered using the GUI, and wherein the cell of the matrix marked with the visual marker corresponds to the aggregated growth rate over the time.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of displaying results of a financial data analysis using a GUI, in accordance with some embodiments of the present invention;

FIG. 2 is a block diagram of components of a system that presents, within a GUI, a matrix of investment strategies, where one cell of the matrix is visually demarcated according to a computation of a growth grade and a value grade computed using a dataset of performance data of companies traded on a stock exchange(s), in accordance with some embodiments of the present invention; and

FIG. 3 is a depiction of a typical strategy matrix where the growth and value grades define a strategy at a certain row and column, in accordance with some embodiments of the present invention.

### DESCRIPTION OF SPECIFIC EMBODIMENTS OF THE INVENTION

The present invention, in some embodiments thereof, relates to a graphical user interface (GUI) and, more particularly, but not exclusively, to methods and systems of displaying financial data analysis using a GUI.

According to an aspect of some embodiments of the present invention there is provided a GUI that displays a financial data analysis as a matrix with multiple available cells, each indicative of a financial strategy. One of the cells of the matrix is visually marked, indicative of a computed financial strategy. The visually marked cell is determined based on a growth grade computed for a defined subset of stocks and a value grade computed for the subset of stocks, which are computed using performance data of the stocks of the companies. The calculation may be performed for a selected date in the past for which the underlying companies' performance data exists.

The growth and value grades are used to select a strategy from a matrix of strategies, where the growth grade determines the row (or column) of the matrix and the value grade determines the column (or row) of the matrix.

The calculations may be applied to a selected sector of stocks (e.g., natural resources, technology, healthcare, real estate). The computed growth and grades may modify the weighting of the selected sector in the current strategy compared to the sector's current weighting in a known benchmark. The GUI is dynamically updated to reflect the updated strategy.

The strategy may include a list of assets and weights for consideration by an asset manager as a structure for the portfolio. For example, a user may select the visually marked cell of the matrix (or another cell), with the GUI presenting the assets and weights associated with the investment strategy of the selected cell.

The systems and/or methods (e.g., code instructions stored in a data storage device executed by one or more processors) described herein do not simply display information using a GUI. The systems and/or methods described herein are based on a specific, structured GUI paired with a prescribed functionality directly related to the GUI's structure that is addressed to and resolves a specifically identified problem.

The systems and/or methods (e.g., code instructions stored in a data storage device executed by one or more processors) described herein provide a technical solution to the problem of rapidly analyzing a large volume of performance data of companies traded on stock exchanges, to determine an overall investment strategy, for example, for a portfolio of a client, and/or for a managed mutual fund. Determination of the overall investment strategy is repeatedly performed, for example, daily or weekly, for example, to account for rapidly changing market and/or economic conditions. Daily adjustments of the overall investment strategy are labor intensive, for example, due to the need to re-evaluate performance of stocks. The GUI described herein provides a mechanism for adapting one or more parameters of the computation of the investment strategy, and rapidly updating the GUI to present the updated investment strategy according to the adapted parameter(s). The investment strategy selection presented by the GUI may be easily executed on a frequency basis (e.g., hourly, daily, weekly), and may optionally be automatically and dynamically updated according to updated data.

The GUI described herein presents an overall investment strategy based on the large volume of performance data of the companies, for example, in comparison to other methods that help select individual stocks by predicting performance of individual stocks.

The systems and/or methods (e.g., code instructions stored in a data storage device executed by one or more processors) described herein improve performance of an existing computer system (e.g., client terminal, server, network), for example, by reducing processor utilization, reducing data traffic over a network, and/or by reducing storage requirements. Improvement may occur, for example, by the dynamic adjustment of the investment strategy presented using the matrix of the GUI according to dynamically entered user adjustments, as compared to, for example, the user manually accessing different data servers to obtain individual data items until the defined data items are obtained.

The systems and/or methods (e.g., code instructions stored in a storage device executed by one or more processors) described herein improve an underlying technical process within the technical field of graphical user interfaces.

The systems and/or methods (e.g., code instructions stored in a storage device executed by one or more processors) described herein are tied to physical real-life components, including displays presenting the GUI, and physical user interfaces for entering data used to dynamically update the GUI.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures.

For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

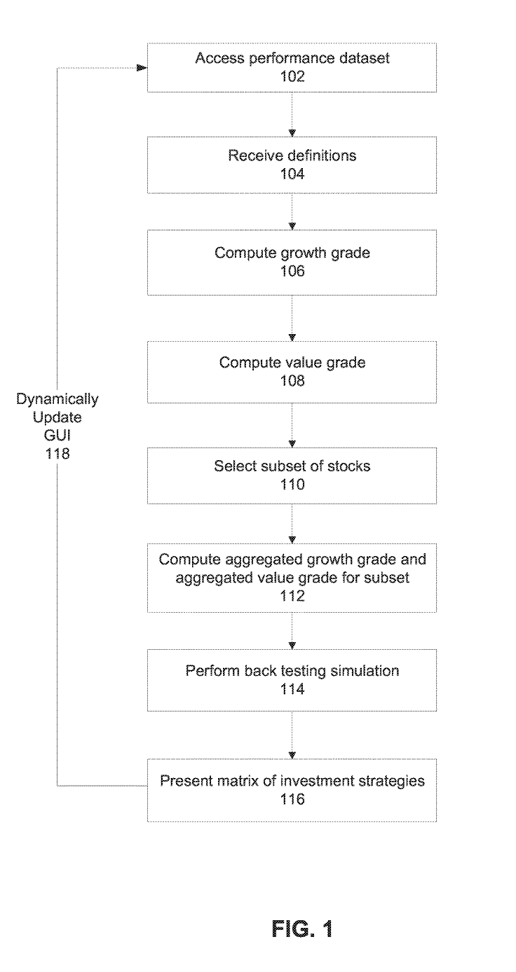

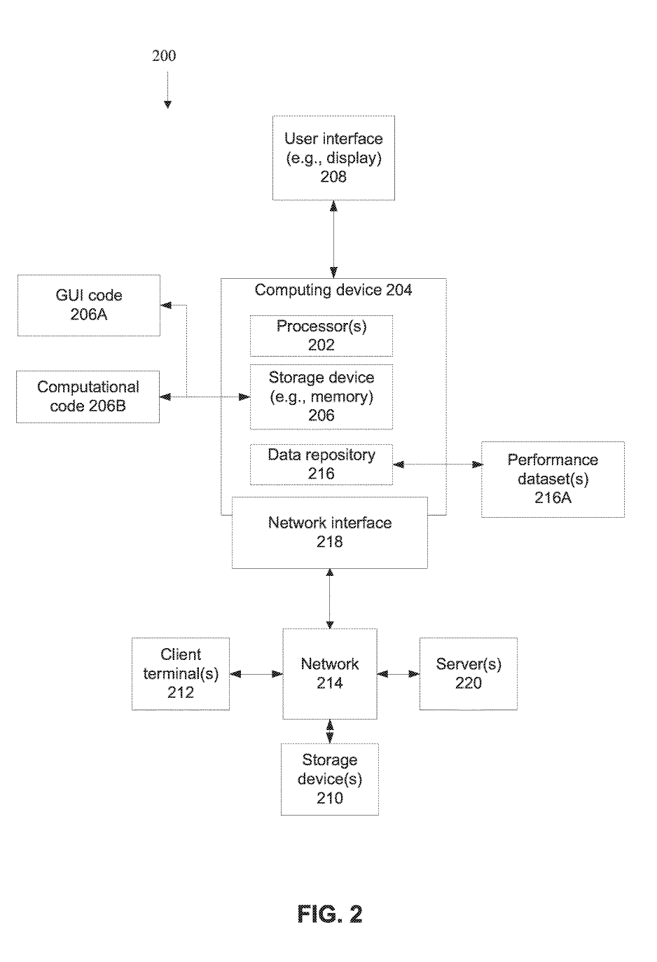

Reference is now made to FIG. 1, which is a flowchart of a method of displaying results of a financial data analysis using a GUI, in accordance with some embodiments of the present invention. Reference is also made to FIG. 2, which is a block diagram of components of a system 200 that presents, within a GUI, a matrix of investment strategies, where one cell of the matrix is visually demarcated according to a computation of a growth grade and a value grade computed using a dataset of performance data of companies traded on a stock exchange(s), in accordance with some embodiments of the present invention. System 200 may implement the acts of the method described with reference to FIG. 1, by processor(s) 202 of a computing device 204 executing code instructions stored in a storage device 206 (also referred to as a program store).

The methods described with reference to FIG. 1, and the systems described with reference to FIG. 2, perform calculation, simulation, and selection of investment strategies using the GUI. The calculation is based on determining growth and value grades for the market defined by the stocks.

Computing device 204 may be implemented as, for example, a client terminal, a server, a computing cloud, a mobile device, a desktop computer, a thin client, a Smartphone, a Tablet computer, a laptop computer, a wearable computer, glasses computer, and a watch computer. Computing device 204 may include locally stored software (e.g., GUI code 206A and/or computation code 206B) that performs one or more of the acts described with reference to FIG. 1, and/or may act as one or more servers (e.g., network server, web server, a computing cloud) that provides services (e.g., one or more of the acts described with reference to FIG. 1) to one or more client terminals 212 over a network 214, for example, providing software as a service (SaaS) to the client terminal(s) 212, providing software services accessible using a software interface (e.g., API, SDK), providing an application for local download to the client terminal(s) 212, and/or providing functions using a remote access session to the client terminals 212, such as through a web browser.

Processor(s) 202 of computing device 204 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 204 may include one or more processors (homogenous or heterogeneous), which may be arranged for parallel processing, as clusters and/or as one or more multi core processing units.

Storage device 206 stores code instructions implementable by processor(s) 202, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Storage device 206 stores GUI code 206A that presents the GUI described herein (e.g., the matrix of investment strategies) and computational code 206B that executes one or more acts of the method described with reference to FIG. 1.

Computing device 204 may include a data repository 216 for storing data, for example, a performance dataset 216A storing performance data of companies that have stocks trading on stock exchanges. Data repository 216 may be implemented as, for example, a memory, a local hard-drive, a removable storage unit, an optical disk, a storage device, and/or as a remote server and/or computing cloud (e.g., accessed using a network connection).

Computing device 204 may include a network interface 218 for connecting to network 214, for example, one or more of, a network interface card, a wireless interface to connect to a wireless network, a physical interface for connecting to a cable for network connectivity, a virtual interface implemented in software, network communication software providing higher layers of network connectivity, and/or other implementations. Computing device 204 may connect using network 214 (or another communication channel, such as through a direct link (e.g., cable, wireless) and/or indirect link (e.g., via an intermediary computing unit such as a server, and/or via a storage device) with one or more of:
Remote servers 220 and/or storage devices 210 using network 214 to access one or more performance datasets 216A, for example, a securities and exchange commission server, a server of a publicly traded company, and a server of an investment research institute.
Remote servers 220 and/or storage devices 210 using network 214 to download updated performance parameters of the companies having stocks traded on stock exchanges, and/or to obtain real-time price quotes of the stocks.
Client terminal(s) 212 (which may include server(s)), for example, when computing device 204 acts as a server providing SAAS. Client terminals 212 may access GUI 206A hosted by computing device 204 to select investment strategies.

Computing device 204 and/or client terminal(s) 212 include and/or are in communication with one or more physical user interfaces 208 that include a mechanism for a user to enter data (e.g., define the growth grade, define the value grade, define the requirement) and/or view the displayed GUI. Exemplary user interfaces 424 include, for example, one or more of, a touchscreen, a display, a keyboard, a mouse, and voice activated software using speakers and microphone.

Referring now back to FIG. 1, one or more of the acts of the method described with reference to FIG. 1 are performed using GUI code 206A. User(s) access GUI code 206A executing on computing device 204 directly using physical user interface 208, and/or remotely over network 214 using the physical user interface associated with client terminal 212. For example, a user may use a keyboard or touchscreen to enter data into the GUI presented on a display of the client terminal.

At 102, one or more performance datasets 216A storing performance data of companies having stocks traded on one or more stock markets is accessed by computing device 204. Performance dataset 216A may be locally stored by computing device 204, and/or reside remotely on server(s) 220 and/or storage device(s) 210.

The stock markets may include general stock markets, for example, the New York Stock Exchange (NYSE), specialized stock markets trading stocks of a certain sector for example, Nasdaq, and TSX Venture Exchange.

Optionally, a selection of a stock set is received using the GUI (e.g., remotely accessed by a user using physical interface 208 of client terminal 212), optionally a sector of stocks, a defined benchmark (which may include stocks trading on different exchanges) and/or stocks trading on a certain stock exchange, for example, the DOW JONES, the S&P500 or the EuroSTOXX 600.

As used herein, the term universe means the set of stocks for which performance data is available. The universe may be defined by the stock set selected by the user using the GUI, for example, all available stocks on all exchanges worldwide, all stocks of all exchanges of a certain country, one or more stock exchanges and/or one or more benchmarks.

At 104, a definition of a growth grade, a definition of a value grade, and/or a definition of a requirement of the growth grade and the value grade are received. The definitions may be dynamically entered by a user using the GUI, and/or retrieved from a storage location (e.g., predefined by an administrator, or previously defined by the user).

Exemplary requirements of the growth grade and/or value grade may include, for example, a defined threshold and/or range of values of the growth and/or value grades. Stocks with value of the growth grade and/or value above (or below) the threshold and/or within the range may be selected for the subset (as described herein).

At 106, the growth grade is computed for the stocks according to the performance data. The growth grade may be computed for all stocks on the selected benchmark and/or stock exchange. The growth grade may be computed for all stocks for which performance data is available.

Optionally, the growth grade is calculated by filtering the universe of stocks by a set-of-rules, which may be received from a user using the GUI, and/or obtained from storage (e.g., defined by an administrator). Examples of the set-of-rules include size, domicile, exchange and sector.

The growth grade is computed for each company having a stock that passed the optional filtering stage, based on fundamental factor(s) obtained from the performance dataset. Examples of fundamental factors stored in the performance dataset include: ratios of the company financial performance, such as profitability, cash/flow and sales.

At 108, the value grade is computed for the stocks according to the performance data. The value grade may be computed for all stocks on the selected benchmark and/or stock exchange. The value grade may be computed for all stocks for which performance data is available.

Optionally, the value grade is calculated by filtering the universe of stocks by the set-of-rules, which may be received from a user using the GUI, and/or obtained from storage (e.g., defined by an administrator). Examples of the set-of-rules include size, domicile, exchange and sector.

The value grade is calculated each company having a stock that passed the optional filtering stage, based on price multiple(s) computed using data from the performance dataset. Examples of price multiples include Price to Earning, Price to Sales and Price to Cash/flow.

At 110, a subset of the stocks is selected according to the requirement of the computed growth grade and value grade computed for each stock of the plurality of stocks.

The requirement is used to select the best graded companies having stocks in the universe of stocks.

At 112, aggregated growth grade and/or an aggregated value grade is computed for the subset of stocks according to the computed growth grade and value grade computed for each stock of the subset of stocks.

The growth grades and the value grades may be aggregated by computing the average of the value of the growth grades and the average of the value of the value grades. The average may determine the value grade of the market. The changes of the average over time may determine the growth grade of the market.

Optionally, the growth grade of the market, the value grade of the market, or a combination of both, determines the current investment strategy at the real-time (i.e., current) moment that the user is setting the GUI to present the investment strategy matrix (as described herein).

Optionally, the growth grade of the sector determines how the sector weight is adjusted, with comparison to the weight of the sector in a known benchmark, such as the S&P500 or the EuroSTOXX 600.

At 114, a back testing simulation of performance of the subset of stocks (selected according to the requirement) is performed. The results of the simulation are compared to a known benchmark, and presented within the GUI. The results may be presented, for example, as numerical values, and/or as a graph. The results of the simulation may be used to evaluate whether the requirement is valid in selecting the top performing stocks.

At 116, a matrix of investment strategies is presented within the GUI. Each cell of the matrix is associated with a certain investment strategy. Each investment strategy is selected according to a row of growth grade values and a column of value grade values. For example, each cell of the matrix denotes a range of growth grade values and a range of value grade values.

A cell of the matrix corresponding to the computed aggregated growth grade and the computed aggregated value grade is marked with a visual marker, for example, highlighted with a distinct color, and/or bolded.

Optionally, an aggregated sector growth grade is computed for stocks of the selected stock sector. The aggregated sector growth grade is used to modify the sector weight as compared to the sector weight in a known benchmark. The GUI presents the investment strategy that is selected according to the aggregated sector growth grade.

Optionally, the investment strategies of cells of the matrix are dynamically updated according to the modified sector weight in comparison to the known benchmark. The GUI dynamically presents the updated investment strategies.

A selection of one of the cells of the matrix is dynamically received using the GUI. Optionally, the selected cell is the visually demarcated cell denoting the selected investment strategy. The GUI presents assets and weights associated with the investment strategy of the selected cell. The assets and weights (e.g., in terms of percentage of total investment funds) define the asset mix within an exemplary portfolio satisfying the investment strategy of the selected cell.

Exemplary investment strategies include: bullish outlook, bearish outlook, and average. The assets and weights selected according to a bullish outlook include, for example, growth stocks. The assets and weights selected according to a bearish outlook include, for example, government bonds and bonds of high quality corporations.

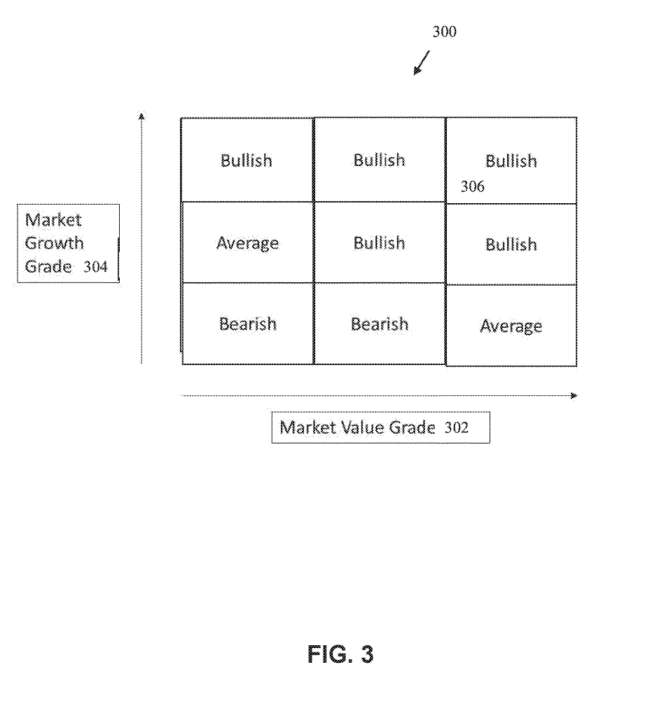

Reference is now made to FIG. 3, which is a schematic of an exemplary investment strategy matrix 300, in accordance with some embodiments of the present invention. Market value grades are represented on X-axis 302, which denotes columns of matrix 300. Market growth grades are represented on Y-axis 304, which denotes rows of matrix 300. Each cell (e.g., one cell 306 depicted for clarity) is associated with an investment strategy corresponding to the market value grades on x-axis 302 and market growth grades on y-axis 304.

Referring now back to FIG. 1, at 118, the investment strategies presented in the matrix in the GUI are dynamically updated based on dynamically received data, by iterating one or more of blocks 102-116. It is noted that block 102 may be executed after block 104.

At 104, one of more of the following may be adjusted dynamically by the user using the GUI: definition of the growth grade, the definition of the value grade, and the definition of the requirement, and the past date when used to compute the grades. For example, the user may dynamically alter a scroll bar denoting different definitions and/or dates, select different options used to define the definitions, and/or enter an adjusted definition and/or date.

At 102, the update of the performance data of one or more of the universe of stocks and/or the selected subset of stocks used to select the investment strategy may be dynamically received, for example, by a publication of the update (e.g., by the server hosting the performance dataset) and/or by accessing the performance dataset (e.g., at predefined frequencies, and/or upon published update events).

At 106-112, a re-computation of the aggregated growth grade and/or aggregated value grade is performed. An updated back test simulation may be performed at 114.

At 116, the visually marked cell in the matrix of investment strategies is updated according to the re-computation.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant graphical user interfaces will be developed and the scope of the term graphical user interface is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method of displaying results of a financial data analysis on a graphical user interface (GUI), comprising:
accessing a dataset storing performance data of a plurality of stocks traded on at least one stock market;
receiving, using the GUI, a definition of a growth grade, a definition of a value grade, and a definition of a requirement of the growth grade and the value grade;
computing the growth grade and the value grade for each of the plurality of stocks according to the performance data;
selecting a subset of the stocks according to the requirement of the computed growth grade and value grade computed for each stock of the plurality of stocks;
computing an aggregated growth grade and an aggregated value grade for the subset of stocks according to the computed growth grade and value grade computed for each stock of the subset of stocks;
presenting, within the GUI, a matrix of investment strategies, where each cell of the matrix stores an investment strategy according to a row and column of ranges of growth grades and value grade, wherein the cell of the matrix corresponding to the aggregated growth grade and the aggregated value grade is marked with a visual marker.

2. The method of claim 1, wherein the aggregated growth and value grades are computed based on the average growth and value grades of the subset of the plurality of stocks and changes in the averages.

3. The method of claim 2, further comprising performing a back testing simulation of performance of the subset of stocks, comparing the results of the stimulation to a known benchmark, and presenting within the GUI the comparison results.

4. The method of claim 1, where the plurality of stocks consist of a stock sector selected using the GUI.

5. The method of claim 1, wherein the growth grade is used to define the rows of the matrix and the value grade is used to define the column of the matrix.

6. The method of claim 4, where an aggregated sector growth grade computed for stocks of the stock sector is used to modify the sector weight as compared to the sector weight in a known benchmark.

7. The method of claim 6, wherein the investment strategies of cells of the matrix are dynamically updated according to the modified sector weight in comparison to the known benchmark, and dynamically presenting the updated investment strategies using the GUI.

8. The method of claim 1, further comprising:
dynamically receiving using the GUI, an adjustment to at least one of: the definition of the growth grade, the definition of the value grade, and the definition the requirement, and dynamically updating the visually marked cell in the matrix of investment strategies according to a re-computation using the dynamic adjustment.

9. The method of claim 1, further comprising:
dynamically receiving an update of the performance data of at least one of the plurality of stocks, and dynamically updating the visually marked cell in the matrix of investment strategies according to a re-computation using the updated performance data.

10. The method of claim 1, further comprising:
dynamically receiving, using the GUI, a past date, and dynamically updating the visually marked cell in the matrix of investment strategies according to a re-computation using the performance data of the past date.

11. The method of claim 1, further comprising:
dynamically receiving, using the GUI, a selection of one of the cells of the matrix, and presenting using the GUI, assets and weights associated with the investment strategy of the selected cell.

12. The method of claim 1, further comprising filtering the stocks according to a set-of-rules defined by a user using the GUI, including one or more of: size, domicile, exchange, and sector.

13. The method of claim 1, further comprising computing changes of the aggregated growth rate over a time interval entered using the GUI, and wherein the cell of the matrix marked with the visual marker corresponds to the aggregated growth rate over the time.

14. A system for displaying results of a financial data analysis on a graphical user interface (GUI), comprising:
a non-transitory memory having stored thereon a code for execution by at least one hardware processor of a computing device, the code comprising:
code for accessing a dataset storing performance data of a plurality of stocks traded on at least one stock market;
code for receiving, using the GUI, a definition of a growth grade, a definition of a value grade, and a definition of a requirement of the growth grade and the value grade;
code for computing the growth grade and the value grade for each of the plurality of stocks according to the performance data;
code for selecting a subset of the stocks according to the requirement of the computed growth grade and value grade computed for each stock of the plurality of stocks;
code for computing an aggregated growth grade and an aggregated value grade for the subset of stocks according to the computed growth grade and value grade computed for each stock of the subset of stocks;
code for presenting, within the GUI, a matrix of investment strategies, where each cell of the matrix stores an investment strategy according to a row and column of ranges of growth grades and value grade, wherein the cell of the matrix corresponding to the aggregated growth grade and the aggregated value grade is marked with a visual marker.

15. A computer program product for displaying results of a financial data analysis on a graphical user interface (GUI), comprising:
a non-transitory memory having stored thereon a code for execution by at least one hardware processor of a computing device, the code comprising:
instructions for accessing a dataset storing performance data of a plurality of stocks traded on at least one stock market;
instructions for receiving, using the GUI, a definition of a growth grade, a definition of a value grade, and a definition of a requirement of the growth grade and the value grade;
instructions for computing the growth grade and the value grade for each of the plurality of stocks according to the performance data;
instructions for selecting a subset of the stocks according to the requirement of the computed growth grade and value grade computed for each stock of the plurality of stocks;
instructions for computing an aggregated growth grade and an aggregated value grade for the subset of stocks according to the computed growth grade and value grade computed for each stock of the subset of stocks;
instructions for presenting, within the GUI, a matrix of investment strategies, where each cell of the matrix stores an investment strategy according to a row and column of ranges of growth grades and value grade, wherein the cell of the matrix corresponding to the aggregated growth grade and the aggregated value grade is marked with a visual marker.
